(19) United States
(12) Patent Application Publication
(10) Pub. No.: US 2012/0161457 A1
(43) Pub. Date: Jun. 28, 2012

(54) STRIKE PLATE FOR SPRING-LATCH LOCKS, PARTICULARLY WITH A MAGNETIC SPRING-LATCH

(75) Inventor: Antonio Mario Alban, Bassano Del Grappa (IT)

(73) Assignee: Alban Giacomo - S.P.A.

(21) Appl. No.: 13/394,087

(22) PCT Filed: Sep. 7, 2010
(86) PCT No.: PCT/IB10/54030

§ 371 Date: Mar. 2, 2012

(30) Foreign Application Priority Data
Sep. 8, 2009 (IT) PD2009A000258
Nov. 13, 2009 (IT) PD2009A000338

(51) Int. Cl. E05B 15/02

(52) U.S. Cl. 292/341.18

(57) ABSTRACT

A strike plate for spring-latch locks, particularly with a magnetic spring-latch, to be associated with a support constituted by a frame of a casing or by a leaf and provided with a spring-latch hole in a position that corresponds to the spring-latch in order to receive it upon closure of the lock. The strike plate comprises: a body, which forms a seat for the spring-latch, to be arranged at the spring-latch hole; at least one protrusion for insertion in the spring-latch hole, which protrudes from the body; elements for locking the protrusion in the spring-latch hole by expansion in a direction that is substantially transverse to a longitudinal direction of the protrusion.

### BACKGROUND OF THE INVENTION

Currently known strike plates comprise a body that forms a seat for the spring-latch and an elongated front on which the seats for the screws for fixing the strike plate to a support, constituted by the frame or by a leaf of a casing, are formed.

In order to receive the strike plate, the support must be machined in order to provide the spring-latch hole and the seat for the front, so that the strike plate is flush with the surface of the support.

These machining operations are generally performed by means of a milling cutter which provides the spring-latch hole, which is narrow and deep with respect to the outline for the front, which is less deep but has a larger extension on the support.

### SUMMARY OF THE INVENTION

The aim of the present invention is to provide a strike plate for spring-latch locks, particularly with a magnetic spring-latch, which requires a machining of the support that is simpler and easier than the machinings currently required to install known strike plates.

Within this aim, an object of the invention is to propose a strike plate that can be installed in supports that have a limited depth, such as frames of glazed casings with thin perimetric borders.

Another object of the invention is to provide a strike plate that allows to conceal the screws or other means adapted to fix it to the support.

Another object of the invention is to propose a strike plate that is structurally simple and easy to use and can be manufactured with low costs.

This aim, as well as these and other objects that will become better apparent hereinafter, are achieved by a strike plate for spring-latch locks, particularly with a magnetic spring-latch, to be associated with a support constituted by a frame of a casing or by a leaf and provided with a spring-latch hole in a position that corresponds to the spring-latch in order to receive it when the lock closes, said strike plate comprising a body which forms a seat for accommodating the spring-latch, to be arranged at said spring-latch hole, characterized in that it comprises
at least one protrusion for insertion in said spring-latch hole, which protrudes from said body,
means for locking said protrusion in said spring-latch hole by expansion in a direction that is substantially transverse to a longitudinal direction of said protrusion.

### BRIEF DESCRIPTION OF THE DRAWINGS

Further characteristics and advantages of the invention will become better apparent from the detailed description that follows of preferred but not exclusive embodiments of the strike plate according to the invention, illustrated by way of non-limiting example in the accompanying drawings, wherein:

FIG. 1 is a transverse sectional view of a strike plate according to the invention in a first embodiment;

FIG. 2 is a transverse sectional view of a strike plate according to the invention in a second embodiment;

FIG. 3 is a transverse sectional view of a strike plate according to the invention in a third embodiment;

FIG. 4 is an enlarged-scale sectional view of a strike plate according to the invention in an installation configuration;

FIG. 5 is a partially exploded perspective view of the strike plate according to the invention;

FIG. 6 is an enlarged-scale sectional view of a detail of the strike plate according to the invention in a configuration for use;

FIG. 7 is an enlarged-scale exploded sectional view of a detail of the strike plate according to the invention.

### DESCRIPTION OF THE PREFERRED EMBODIMENTS

It is noted that anything found to be already known during the patenting process is understood not to be claimed and to be the subject of a disclaimer.

With reference to the figures, the reference numeral 10 generally designates a strike plate for spring-latch locks, particularly with a magnetic spring-latch, to be associated with a support 11 constituted by a frame of a casing or by a leaf and provided with a spring-latch hole 12 in a position that corresponds to the spring-latch in order to receive it when the lock closes.

The strike plate 10 comprises a body 13 which forms a seat 14 for the spring-latch, to be arranged at the spring-latch hole 12, and comprises a protrusion 15 for insertion in the spring-latch hole 12, which protrudes from the body 13, and means for locking the protrusion 15 in the spring-latch hole 12 by expansion in a direction that is substantially transverse to a longitudinal direction B of the protrusion 15.

Advantageously, such locking means comprise
expansion wings 16, which are jointly connected to the protrusion 15 and are adapted to be divaricated by the protrusion 15 in an opening direction A that is substantially transverse to a longitudinal direction B of the protrusion 15, the longitudinal direction B substantially coinciding, during use, with the longitudinal direction of the spring-latch hole 12 in the frame,
means 17 for divaricating the wings 16 from the protrusion 15.

Advantageously, the wings 16 are provided with teeth on the side that is adapted to abut against the wall of the spring-latch hole 12, in order to retain therein the strike plate 10, when they are divaricated from the protrusion 15.

Moreover, the wings 16 are conveniently integral with the protrusion 15, preferably made of plastics, and can be divaricated elastically from it reversibly by way of the divarication means 17.

Thus, by activating the divarication means 17 it is possible to
divaricate the wings 16 from the protrusion 15, or
vice versa, when they are divaricated, allow their return toward the protrusion 15, respectively
to cause their engagement with the walls of a spring-latch hole 12 in which the protrusion 15 is inserted, in order to block to the support 11 the strike plate 10, or
vice versa to release the strike plate 10 and allow its removal from the support 11.

In a substantially equivalent manner, in alternative embodiments of the invention the strike plate can obviously comprise more than one of such protrusions.

Advantageously, the body 13 comprises two shoulders 18 provided on opposite sides of the seat 14 and provided with threaded holes 19.

The divarication means 17 conveniently comprise threaded elements 20, which are adapted to be screwed into the threaded holes 19 and are provided with an end portion 21 for interaction with the wings 16, which have at least one portion 22 for interaction with the end portion 21 arranged at an end of the threaded holes 19 and adapted to undergo the action of the end portion 21 in order to divaricate the wings 16 from the protrusion 15.

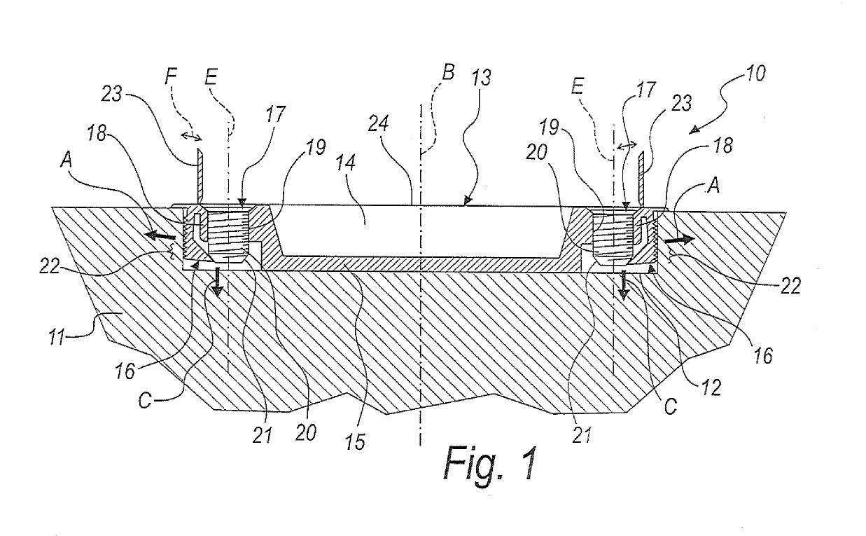

In a first embodiment of the strike plate 10, as shown for example in FIG. 1, the end portion 21 is preferably wedge-shaped and the portion 22 is ramp-shaped and complementary to the end portion 21 and faces the threaded hole 19 in order to interfere with the end portion 21 at a predefined protrusion thereof from the threaded hole 19.

Thus, in order to divaricate the wing 16 from the protrusion 15 it is sufficient to screw the threaded element 20 into the threaded hole 19 in a predefined direction of insertion C of the protrusion 15 in the spring-latch hole 12.

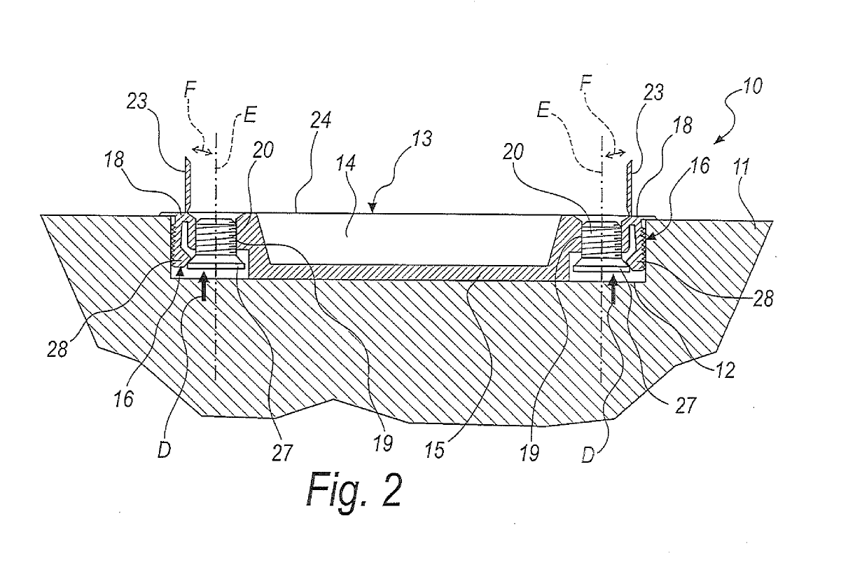

In a second embodiment of the strike plate 10, as shown for example in FIG. 2, the end portion 27 is conveniently enlarged, being for example frustum-shaped and diverging from the axis of the threaded element 20.

The portion 28 is conveniently shaped like a ramp which is complementary to the end portion 27, and when the wing 16 is not divaricated from the protrusion 15 it is substantially aligned with the part of the end portion 27 that protrudes with respect to the remaining part of the threaded element 20.

Thus, in order to divaricate the wing 16 from the protrusion 15 it is sufficient to unscrew the threaded element 17 from the threaded hole 19, along a predefined direction of extraction D of the protrusion 15 from the spring-latch hole 12, in order to cause the interference of the end portion 27, which by pressing against the portion 22 divaricates the wing 16, pushing it against the wall of the spring-latch hole 12, locking the strike plate 10 thereat.

Conveniently, the axis E of the threaded holes 19 is substantially parallel to the longitudinal direction B, as shown for example in FIGS. 1 and 2.

As an alternative, in a third embodiment of the strike plate 10 according to the invention, advantageously the axis E of the threaded holes 19 is substantially oblique to the longitudinal direction B, the threaded holes 19 facing internally the seat 14.

Thus, they are concealed from sight since they are located in the seat 14 adapted to accommodate the spring-latch of the lock.

In particular, preferably the axis E of the threaded holes 19 diverges from the longitudinal direction B along a predefined direction E of insertion of the protrusion 15 in the spring-latch hole 12.

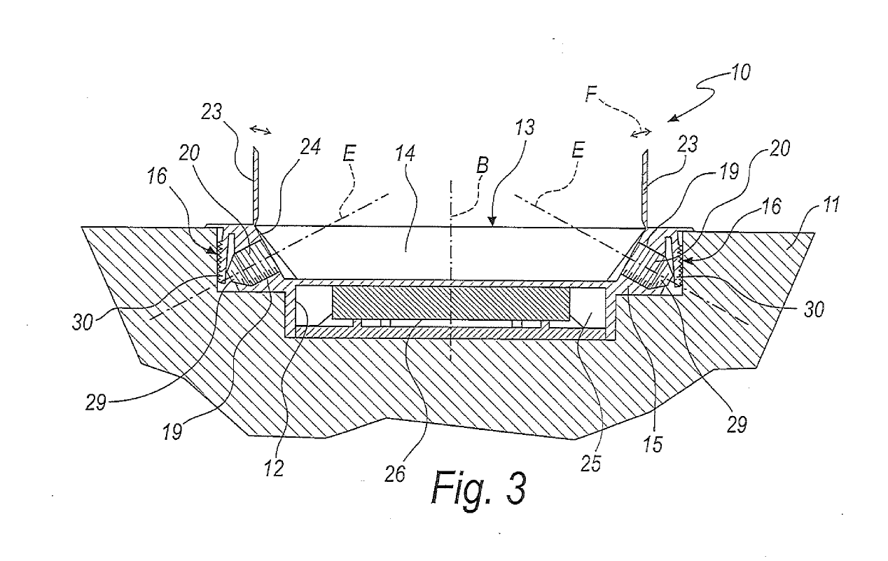

FIG. 3 illustrates by way of non-limiting example a third embodiment of the strike plate 10, which further has heads 29, threaded elements 20, which are substantially conical, the portions 30 of the wings 16 adapted to interfere with the heads 29 being substantially flat.

Moreover, a strike plate 10 according to the invention advantageously comprises faceplates 23 for covering the threaded holes 19, which are adapted to conceal their view on a face 24 of the body 13 that is exposed by the support 11 during use.

Conveniently, the faceplates 23 are pivoted to the body 13 proximate to the opening of the threaded holes 19 on the face 24 and in particular are preferably integral with the body 13, the faceplates 23 and the body 13 being made of plastics.

Depending on the requirements, the protrusion 15 can have different shapes, as in particular in the application for a magnetically reactive spring-latch lock, the protrusion can have, at the bottom of the seat 14, a chamber 25 for accommodating a magnetic element 26 for return of the spring-latch, as shown for example in FIG. 3.

The use of a strike plate 10 according to the invention is as follows.

The person who installs a strike plate 10 according to the invention inserts its protrusion 15 in the spring-latch hole 12 of the support 11, which is designed to receive it.

Then, for example for a strike plate 10 provided according to the first embodiment, he screws the threaded elements 20 into the threaded holes 19, in the direction of insertion C, so that the end portions 21 push on the portions 22 of the wings 16, which thus divaricate from the protrusion 15 and engage the walls of the spring-latch hole 12, locking the strike plate 10 against it.

When provided, the faceplates 23 can be closed on the threaded holes 19 by their rotation F.

In order to remove the strike plate 10 from the support 11, the operator
exposes the threaded elements 20, exposing the threaded holes 19 for rotation of the faceplates 23, if provided,
unscrews the threaded elements 19 at least until an elastic return of the wings 16 to the protrusion 15 is allowed which is such as make them disengage the walls of the spring-latch hole 12, thus freeing the strike plate 10 from the support 11.

Likewise, in such second embodiment, the wings 16 are divaricated by unscrewing the threaded elements 20 with respect to the threaded holes 19 in order to move them in the extraction direction D.

Thus, in fact, the end portions 27 push against the portions 28, divaricating the wings 16 against the walls of the spring-latch hole 12.

Vice versa, the screwing of the threaded elements 20 into the threaded holes 19 allows the relaxation of the wings 16, which return elastically to arrange themselves adjacent to the protrusion 15, disengaging the walls of the spring-latch hole 12 and freeing the strike plate 10 from the support 11.

The use of a strike plate 10 provided in the third embodiment is entirely similar to the use described for a strike plate in the first embodiment.

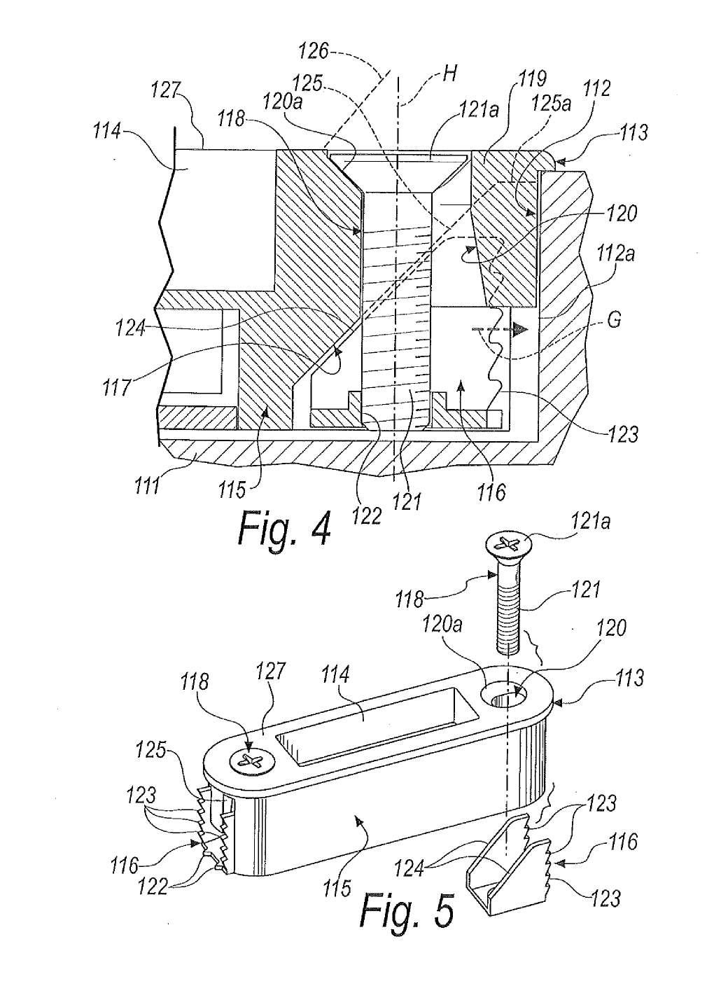

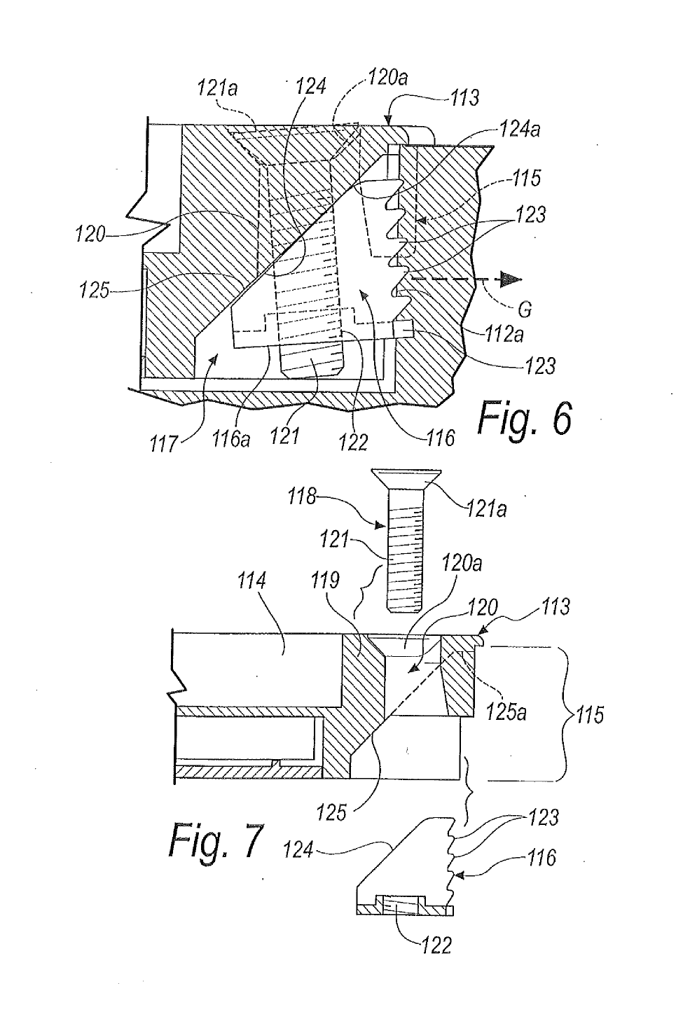

With particular reference to FIGS. 4 to 7, the reference numeral 100 generally designates a flush-mount strike plate for spring-latch locks, particularly with a magnetic spring-latch, to be associated with a support 111 constituted by a frame of a casing or by a leaf and provided with a spring-latch hole 112 in a position that corresponds to the spring-latch in order to receive it upon closure of the lock.

The strike plate 100 comprises a body 113, which forms a seat 114 for the spring-latch, to be arranged at the spring-latch hole 112, and further comprises a protrusion 115 for insertion in the spring-latch hole 112, which protrudes from the body 113, and means for locking the protrusion 115 in the spring-latch hole 112 by expansion in a direction that is substantially transverse to a longitudinal direction H of the protrusion 115.

Where, advantageously, such locking means comprise
expansion wedges 116, which during use are coupled slidingly to corresponding ramp-like guides 117, which are provided on the protrusion 115 and form for the wedges 116 a direction of expansion G that is substantially transverse to a longitudinal direction H of the protrusion 115, such longitudinal direction H substantially coinciding, during use, with the longitudinal direction H of the spring-latch 112 in the frame,
means 118 for sliding the wedges 116 on the ramp-like guides 117 of the protrusion 115.

Thus, in general, depending on the contingent requirements of embodiment of the invention, a strike plate according to the invention can have wings that can be divaricated from the protrusion by way of divarication means and/or, in a substantially equivalent manner, wedges that can be expanded from the protrusion by way of sliding means, wherein during use the wedges and the wings, expanded from the protrusion, perform the same function of locking the protrusion in the seat of the support adapted to accommodate it.

In alternative and substantially equivalent embodiments of a strike plate according to the invention, the body can comprise more than one protrusion; further, in general it can comprise at least one expansion wedge and at least one corresponding ramp-like guide.

Advantageously, the wedges 116 are two and the ramp-like guides 117 are correspondingly two.

Such guides are conveniently provided below two shoulders 119 of the body 113, which lie opposite with respect to the seat 114 and have slotted holes 120 that extend within the body 113 substantially in the longitudinal direction H.

The sliding means 118 preferably comprise threaded elements 121, adapted to be inserted through the slotted holes 120 and mated with threaded seats 122 provided in the wedges 116.

In order to lock the strike plate 100 to the support 111 when it is inserted in the spring-latch hole 112, the threaded elements 121 are screwed reversibly in the threaded seats 122 so as to pull the wedges 116 along the ramp-like guides 117, making them protrude in the direction of expansion G from the protrusion 115 against the internal walls 112a of the spring-latch hole 112.

The wedges 116 advantageously have a substantially U-shaped transverse cross-section, being provided with teeth 123 on a first longitudinal face thereof, which is adapted to engage the inside wall 112a of the spring-latch hole 112.

The second face of the wedges 116, which lies opposite the first face, conveniently has inclined edges 124, with respect to the first face, which are slidingly coupled to slots 125 whose bottom is inclined with respect to the longitudinal direction H so as to form the ramp-like guides 117.

Preferably, the wedges 116 are made of metallic material, particularly advantageously of U-shaped folded metal plate, one of the threaded seats 122 being provided on its base 116a.

Conveniently, the threaded elements 121 comprise screws, the slotted holes 120 being provided with inlets 120a which are recessed in the body 113 to accommodate the heads 121a of the screws when they are fastened to the wedges 116.

As illustrated by way of non-limiting example in FIG. 6, the screwing of the threaded elements 121 to the wedges 116 forces an approach of the bases 116a to the heads 121a, which are retained in the inlets 120a.

Thus, during this screwing, the inclined edges 124 are pushed into abutment against the bottoms of the slots 125, on which they accordingly slide since they are inclined with respect to the direction of traction of the wedges, which coincides substantially with the longitudinal direction H.

Due to this sliding, an axial offset of the slotted holes 120 and of the threaded seats 122 occurs and therefore the threaded elements 121 rotate substantially with respect to their heads 121a which are pivoted in the inlets 120a.

This rotation of the threaded elements 121 induces a substantially joint rotation of the wedges 116, except for a relative mutual inclination caused by a coupling play that is advantageously provided between the threaded elements 121 and the threaded seats 122.

Thus, when the threaded elements 121 are tightened onto the wedges 116, they slide in order to extend from the protrusion 115 in the expansion direction G and oscillate by pivoting in the slots 125 at rounded ends 124a of the inclined edges 124, as illustrated by way of non-limiting example in FIG. 6.

The strike plate 100 further conveniently comprises faceplates 126 for covering the slotted holes 120 which are adapted to conceal them from sight on the front 127 of the body 113, which during use is exposed by the support 111.

In the accompanying figures, the faceplates 126 are shown only in FIG. 4 schematically by means of a segment drawn in dashes.

Preferably, the faceplates 126 are pivoted to the body 113 proximate to the inlets 120a in order to be able to cover them and are conveniently integral with the body 113, being made of plastics.

The use of a strike plate 100 according to the invention is as follows.

The person who installs a strike plate 100 according to the invention inserts its protrusion 115 in the spring-latch hole 112 of the support 111, which is designed to receive it

He then screws the threaded elements 121, so that the wedges 116 pulled against the ramp-like guides 117 are made to extend by them from the protrusion 115, in the expansion direction G, against the walls 112a of the spring-latch hole 112 that engage the teeth 123.

The strike plate 100 is thus locked to the support 111. When provided, the faceplates 126 can be closed on the slotted holes 120 in order to conceal them. To remove the strike plate 100 from the support 111, the operator
exposes the heads 121a of the threaded elements 121, exposing them by rotation of the faceplates 126 if provided,
unscrews the threaded elements 121 at least until a return of the wedges 116 is allowed toward the protrusion 115 such as to make them disengage the walls 112a of the spring-latch hole 112, thus freeing the strike plate 100 from the support 111.

In practice it has been found that the invention achieves the intended aim and objects, providing a strike plate for spring-latch locks, particularly with a magnetic spring-latch, that requires a machining of the support that is simpler and easier than the machinings currently required to install known strike plates; a strike plate according to the invention, by being fixed inside the spring-latch hole by means of the wings that can be divaricated or by means of the expansion of the wedges, might not have a front and therefore the machining of the support to provide the seat of the front is not required and only machining to provide the spring-latch hole is required.

Moreover, a strike plate according to the invention can be installed easily in shallow supports, such as frames of glazed casings with narrow perimetric borders, since the locking of the strike plate occurs from the inside of the spring-latch hole, without therefore requiring screws that penetrate into the support.

A strike plate according to the invention further allows to conceal the threaded elements adapted to fix it to the support, since it is provided with the faceplates or such elements face the spring-latch insertion seat.

Further, a strike plate according to the invention is structurally simple and easy to use and can be manufactured with relatively low costs.

The invention thus conceived is susceptible of numerous modifications and variations, all of which are within the scope of the appended claims; all the details may further be replaced with other technically equivalent elements.

In practice, the materials employed, so long as they are compatible with the specific use, as well as the contingent shapes and dimensions, may be any according to requirements and to the state of the art.

The disclosures in Italian Patent Applications No. PD2009A000258 and No. PD2009A000338, from which this application claims priority, are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-18. (canceled)

19. A strike plate for spring-latch locks, particularly with a magnetic spring-latch, to be associated with a support constituted by a frame of a casing or by a leaf and provided with a spring-latch hole in a position that corresponds to the spring-latch in order to receive it upon closure of the lock, said strike plate comprising a body that forms a seat for the spring-latch, to be arranged at said spring-latch hole, and further comprising
at least one protrusion for insertion in said spring-latch hole, which protrudes from said body,
means for locking said protrusion in said spring-latch hole by expansion in a direction that is substantially transverse to a longitudinal direction of said protrusion; wherein said locking means comprise
expansion wings, which are jointly connected to said protrusion and are adapted to be divaricated by said protrusion in an opening direction that is substantially transverse to a longitudinal direction of said protrusion, said longitudinal direction substantially coinciding, during use, with the longitudinal direction of said spring-latch hole in said frame,
means for divaricating said wings from said protrusion;
or in that said locking means comprise
at least one expansion wedge, which during use is mated slidingly with at
least one corresponding ramp-like guide, which is provided on said protrusion and defines for said at least one wedge an expansion direction that is substantially transverse to a longitudinal direction of said protrusion, said longitudinal direction substantially coinciding, during use, with the longitudinal direction of said spring-latch hole in said frame,
means for the sliding of said at least one wedge on said at least one ramp-like guide of said protrusion.

20. The strike plate according to claim 19, wherein said body comprises two shoulders, which are provided at opposite sides of said seat and have threaded holes, said divarication means comprising threaded elements, which are adapted to be screwed into said threaded holes and are provided with an end portion for interaction with said wings, said wings being elastically divaricatable from said protrusion and having at least one portion for interaction with said end portion, which is arranged at one end of said threaded holes and is adapted to undergo the action of said end portion for the divarication of said wings from said protrusion.

21. The strike plate according to claim 20, wherein said end portion is wedge-shaped in order to divaricate said wing from said protrusion upon the screwing of said threaded element in said threaded hole, in a predefined direction of insertion of said protrusion in said spring-latch hole.

22. The strike plate according to claim 20, wherein said end portion is enlarged and is adapted to divaricate said wing from said protrusion when said threaded element is unscrewed from said threaded hole, along a predefined direction of extraction of said protrusion from said spring-latch hole.

23. The strike plate according to claim 20, wherein the axis of said threaded holes is substantially parallel to said longitudinal direction.

24. The strike plate according to claim 20, wherein the axis of said threaded holes is substantially oblique to said longitudinal direction, said threaded holes facing said seat internally.

25. The strike plate according to claim 23, wherein the axis of said threaded holes diverges from said longitudinal direction in a predefined direction of insertion of said protrusion in said spring-latch hole.

26. The strike plate according to claim 20, further comprising faceplates for covering said threaded holes, which are adapted to hide them from sight on a face of said body that is exposed by said support during use.

27. The strike plate according to claim 24, wherein said faceplates are hinged to said body proximate to the opening of said threaded holes on said face.

28. The strike plate according to claim 24, wherein said faceplates are integral with said body, being made of plastics.

29. The strike plate according to claim 19, wherein said at least one wedge comprises two wedges, said at least one ramp-like guide comprising two ramp-like guides, which are provided below two shoulders of said body, which are opposite with respect to said seat and have slotted holes that extend substantially in said longitudinal direction, said sliding means comprising threaded elements which are adapted to be inserted so as to pass through said slotted holes and are mated with threaded seats provided in said wedges, said threaded elements being adapted to be screwed reversibly in said threaded seats for the traction of said wedges along said ramp-like guides in said expansion direction.

30. The strike plate according to claim 29, wherein said at least one wedge has a substantially U-shaped transverse cross-section, being provided with teeth on a first longitudinal face thereof, which is adapted to engage an internal wall of a spring-latch hole, said second face being inclined with respect to said first face and being mated slidingly with slots whose bottom is inclined with respect to said longitudinal direction and which form said ramp-like guides on said body.

31. The strike plate according to claim 29, wherein said wedge is made of metallic material.

32. The strike plate according to claim 29, wherein said at least one wedge is made of metal plate bent into a U-shape and is provided on a base thereof with one of said threaded seats.

33. The strike plate according to claim 29, wherein said threaded elements comprise screws, said slotted holes having inlets which are countersunk in said body, in order to accommodate the heads of said screws, when they are tightened onto said wedges.

34. The strike plate according to claim 29, further comprising faceplates for covering said slotted holes, which are adapted to conceal them from view on a front of said body that is exposed by said support.

35. The strike plate according to claim 34, wherein said faceplates are hinged to said body proximate to the inlet of said slotted holes.

36. The strike plate according to claim 34, wherein said faceplates are integral with said body, being made of plastics.
